(19) United States
(12) Patent Application Publication
(10) Pub. No.: US 2025/0076604 A1
(43) Pub. Date: Mar. 6, 2025

(54) FIBER OPTIC NETWORK RACK SYSTEM WITH VERTICALLY MOVABLE RACK ASSEMBLIES

(71) Applicant: CORNING RESEARCH & DEVELOPMENT CORPORATION, Corning, NY (US)

(72) Inventor: Lee Alexander Webb, Huntersville, NC (US)

(21) Appl. No.: 18/784,168

(22) Filed: Jul. 25, 2024

Related U.S. Application Data
(60) Provisional application No. 63/536,733, filed on Sep. 6, 2023.

(51) Int. Cl. G02B 6/44; A47B 57/06

(52) U.S. Cl. CPC G02B 6/44526; A47B 57/06; A47B 2220/0002

(57) ABSTRACT

A rack system of a fiber optic network is disclosed. The rack system includes an equipment rack having a first vertical frame member opposing a second vertical frame member. The rack system includes a plurality of rack assemblies are arranged in a stack in the equipment rack between the first vertical frame member and the second vertical frame member with at least a first rack assembly being vertically movable relative to an adjacent second rack assembly. Each of the plurality of rack assemblies is configured to facilitate one or more optical connections of the fiber optic network. The rack system further includes at least one spacing apparatus that is selectively operable to vertically move the first rack assembly relative to the second rack assembly to create a working space therebetween.

### PRIORITY APPLICATION

This application claims the benefit of priority of U.S. Provisional Application No. 63/536,733, filed on Sep. 6, 2023, the content of which is relied upon and incorporated herein by reference in its entirety.

### TECHNICAL FIELD

This disclosure relates generally to fiber optic networks, and more particularly to a network equipment rack system through which fiber optic cables are routed.

### BACKGROUND

The large amount of data and other information transmitted over the internet has led businesses and other organizations to develop large scale fiber optic networks for organizing, processing, storing and/or disseminating large amounts of data. Network design and cabling-infrastructure architecture are becoming increasingly large and complex to handle growing industry needs.

There are many different network architectures, and the various tasks required to distribute optical signals (e.g., splitting, splicing, routing, connecting subscribers) can occur at several locations. Regardless of whether a location is considered a central office, local convergence point, network access point, subscriber premise, or something else, fiber optic equipment is used to house components that carry out one or more of the tasks. The fiber optic equipment at these locations may include a variety of devices, such as fiber distribution hubs (FDHs), cabinets, closures, network interface devices (NIDs), and distribution frames. Organizing fiber optic cables within this equipment can be a challenge, but it is important to do so properly in order to ensure efficient operation and prevent damage to the cables.

Although most current cabling infrastructure architecture is satisfactory for present industry needs, the increasing density of equipment trays and feeder cables within racks requires a more adaptable and dependable cable management system, particularly for equipment trays or equipment rack assemblies that are arranged in a stack within the network equipment racks. To this end, the ever-increasing optical fibers and connector density within racks requires more technician time for installation and maintenance. This drives the costs of installation and maintenance of fiber optic networks.

Therefore, a need exists for improved network equipment racks, assemblies, and systems that are more flexible, efficient, and capable of maintaining or easing installation, maintenance, and access given the growing density of optical fibers and connectors.

### SUMMARY

In one aspect of the disclosure, a rack system of a fiber optic network is disclosed. The rack system includes an equipment rack having a first vertical frame member opposing a second vertical frame member and a plurality of rack assemblies arranged in a stack in the equipment rack between the first vertical frame member and the second vertical frame member. In that regard, at least a first rack assembly is vertically movable relative to an adjacent, second rack assembly. Each of the plurality of rack assemblies are configured to facilitate one or more optical connections of the fiber optic network. The rack system further includes at least one spacing apparatus that is selectively operable to vertically move the first rack assembly relative to the second rack assembly to create a working space therebetween. This increase in working space between rack assemblies provides a technician with more room for tasks such as rerouting fiber optic cables, installing new fiber optic cables, securing connectors onto the designated isolated rack assembly or assemblies, and making fiber optic connections at a targeted rack assembly, for example.

According to one embodiment of the invention, a height of each of the plurality of rack assemblies may be approximately 1 U.

According to another embodiment of the invention, the first rack assembly may be positioned above the second rack assembly and vertical movement of the first rack assembly may be upward relative to the second rack assembly to create the working space. In another embodiment, the at least one spacing apparatus may be configured to vertically move the first rack assembly and an upper portion of the plurality of rack assemblies in the stack that is positioned above the first rack assembly. For example, the at least one spacing apparatus may comprise a scissor lift. In that regard, the scissor lift may be secured between the first rack assembly and the second rack assembly. In one embodiment, the scissor lift may be selectively operable with a handheld tool. In yet another embodiment, the rack system may include a scissor lift positioned between each one of the plurality of rack assembles. Each scissor lift may be operable to vertically move an upper portion of the plurality of rack assemblies in the stack relative to a lower portion of the plurality of rack assemblies in the stack to create a working space therebetween.

According to another embodiment of the invention, the at least one spacing apparatus may comprise a motorized drive configured to vertically move the first rack assembly relative to the second rack assembly. For example, the motorized drive may include a gear located on the first rack assembly that is configured to engage a track located on the equipment rack to drive vertical movement of the first rack assembly. The gear may be selectively driven by a motor.

According to yet another embodiment of the invention, at least the first rack assembly may includes a first bracket configured to engage the first vertical frame member and a second bracket configured to engage the second vertical frame member, wherein one of the first or second brackets houses the gear and motor and a corresponding one of the first or the second vertical frame members includes the track. According to another embodiment, the at least one spacing apparatus may comprise a plurality of motorized drives. Each motorized drive may be configured to vertically move one of the plurality of rack assemblies.

According to one embodiment of the invention, the rack system further includes a controller operatively connected to each motorized drive and a human machine interface (HMI) operatively connected to the controller. The HMI is configured to receive an operation input from a user. The controller being is configured to operate the rack system as follows: receive an operation input from the HMI indicative of the second rack assembly and operate at least the motorized drive of the first rack assembly to vertically move the first rack assembly relative to the second rack assembly to create the working space therebetween.

In another embodiment, an intermediate distribution frame of the fiber optic network may include the rack system according to any one of the embodiments described above.

According to another aspect of the invention, a method of separating adjacent rack assemblies in a rack system of a fiber optic network is disclosed. The method includes providing a rack system that includes an equipment rack with a first vertical frame member opposing a second vertical frame member and a plurality of rack assemblies arranged in a stack in the equipment rack between the first vertical frame member and the second vertical frame member. One or more of the plurality of rack assemblies is vertically movable relative to the equipment rack by means of at least one spacing apparatus. The method includes operating the at least one spacing apparatus to vertically move at least a first rack assembly relative to at least a second rack assembly to create a working space therebetween.

According to one embodiment of the invention, the at least one spacing apparatus may comprises a plurality of motorized drives or a plurality of scissor lifts. Each motorized drive or scissor lift may be configured to vertically move one of the plurality of rack assemblies. The method may further include operating at least one motorized drive or scissor lift to vertically move the first rack assembly relative to the second rack assembly to create the working space therebetween. In another embodiment, the rack system may further include a controller operatively connected to each motorized drive and a human machine interface (HMI) operatively connected to the controller. The HMI may be configured to receive an operation input from a user, where the operation input is indicative of a targeted rack assembly of one of the plurality of rack assemblies. The method may further include receiving by the controller the operation input from the HMI indicative of the targeted rack assembly and operating at least the motorized drive of a rack assembly directly above the targeted rack assembly to vertically move the rack assembly directly above the targeted rack assembly to create the working space therebetween.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a data center campus in which embodiments of the disclosure may be used.

FIG. 2 is a partial perspective view of an exemplary data hall of the data center shown in FIG. 1 according to one embodiment of the disclosure.

FIG. 2A is a partial perspective view of a row of equipment racks of the exemplary data hall shown in FIG. 2.

FIG. 3 is a front view of a rack system in accordance with one embodiment of the disclosure.

FIGS. 4A and 4B are views similar to FIG. 3, illustrating certain rack assemblies moved within the rack system to create working space around a selected rack assembly.

FIG. 5A is a front view of a rack system in accordance with another embodiment of the disclosure.

FIG. 5B is a partial cross-sectional view of a spacing apparatus of one rack assembly of the rack system of FIG. 5A.

FIG. 6 is a schematic view illustrating an exemplary carrier network including a passive optical network in which embodiments of the disclosure may be used.

### DETAILED DESCRIPTION

Embodiments of the present disclosure pertain to a rack system for managing fiber optic cables in a fiber optic network, such as a data center or a FTTx carrier network, for example. In particular, embodiments of the disclosure are directed to a rack system and a method for managing fiber optic feeder cables that are connected to rack assemblies within a network rack of the rack system, for example. In that regard, the rack system may include an equipment rack that supports a plurality of movable rack assemblies arranged in a stack within the equipment rack. Each rack assembly in the equipment rack is capable of vertical movement, allowing one or more rack assemblies in the stack to be moved to isolate one or more rack assemblies targeted for maintenance or installation activities, for example. In that regard, one or more of the rack assemblies may be vertically moved to increase the available working space above and/or below a rack assembly targeted for maintenance or installation activities. This process may be repeated to create or increase a working space around any number of rack assemblies in the equipment rack.

The rack system, as will be described in various embodiments of this disclosure, provides a technician with the ability to temporarily increase the working space around specific rack assemblies located within the equipment rack. For example, this may provide the technician with the ability to use both hands for tasks such as rerouting fiber optic cables, installing new fiber optic cables, securing connectors onto the designated isolated rack assembly or assemblies, and making fiber optic connections at a targeted rack assembly. Furthermore, this may allow the technician to easily access the top, bottom, and rear sides of the isolated rack assembly or assemblies, which are typically difficult to access when the rack assemblies are closely arranged in a stack within the equipment rack. Additionally, the fiber optic cables routed through the rack assemblies remain largely undisturbed during the vertical movement of the plurality of rack assemblies within the equipment rack. Hence, there is no need to disconnect optical fibers before moving one or more of the rack assemblies. These and other benefits and advantages of the present disclosure will be described in greater detail below.

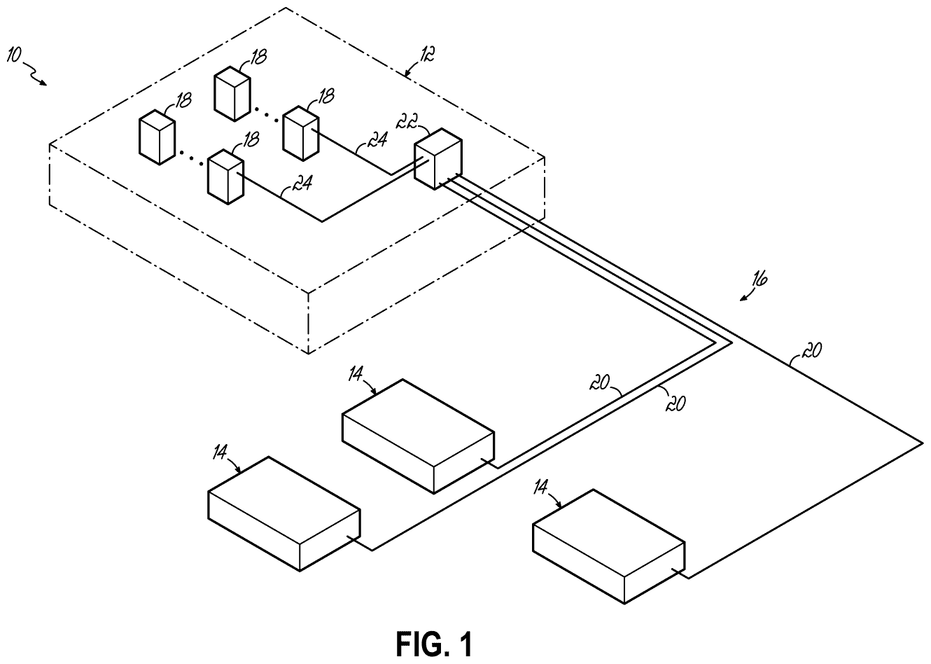

Referring now to FIG. 1, an exemplary modern-day data center 10 is illustrated. The data center 10 may include a collection of buildings (referred to as a data center campus) having, for example, a main building 12 and one or more auxiliary buildings 14 in close proximity to the main building 12. While three auxiliary buildings 14 are shown, there may be more or less depending on the size of the campus. The data center 10 provides for a local fiber optic network 16 that interconnects the auxiliary buildings 14 with the main building 12. The local fiber optic network 16 allows network equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 (“indoor cables 24”) are routed between the network equipment 18 and the one or more distribution cabinets 22. The indoor cables 24 generally include a high fiber-count arrangement of optical fibers for passing data and other information from the distribution cabinets 22 to the network equipment 18. Each of the auxiliary buildings 14 may further include indoor cables 24 that extend between network equipment 18 and the one or more distribution cabinets 22 of the auxiliary building 14. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above.

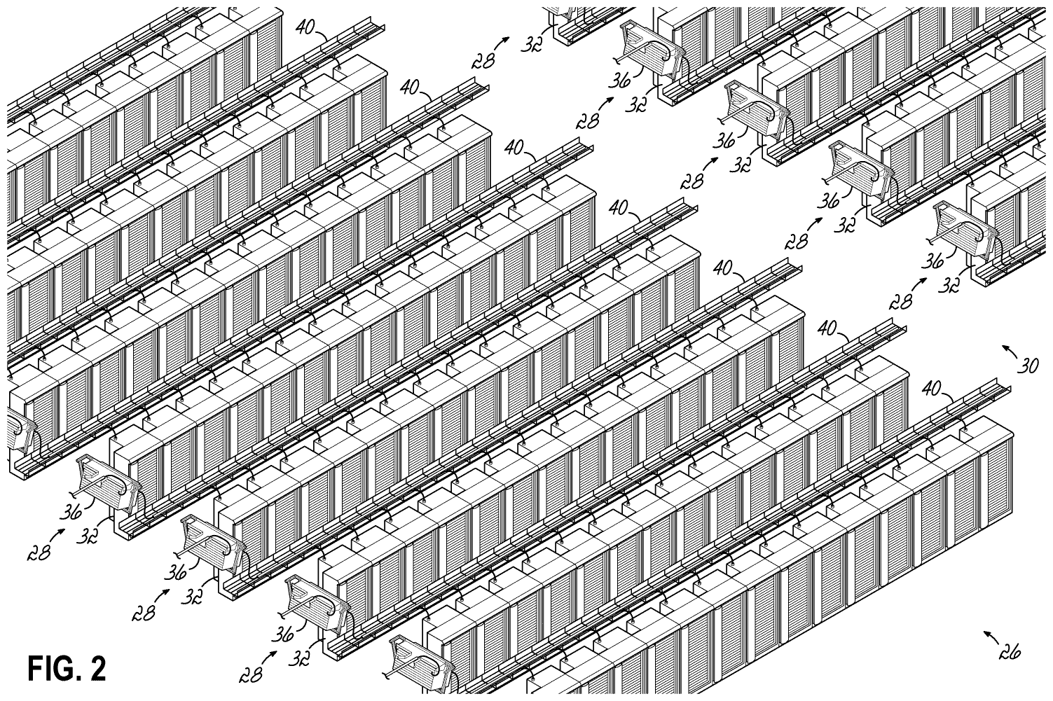

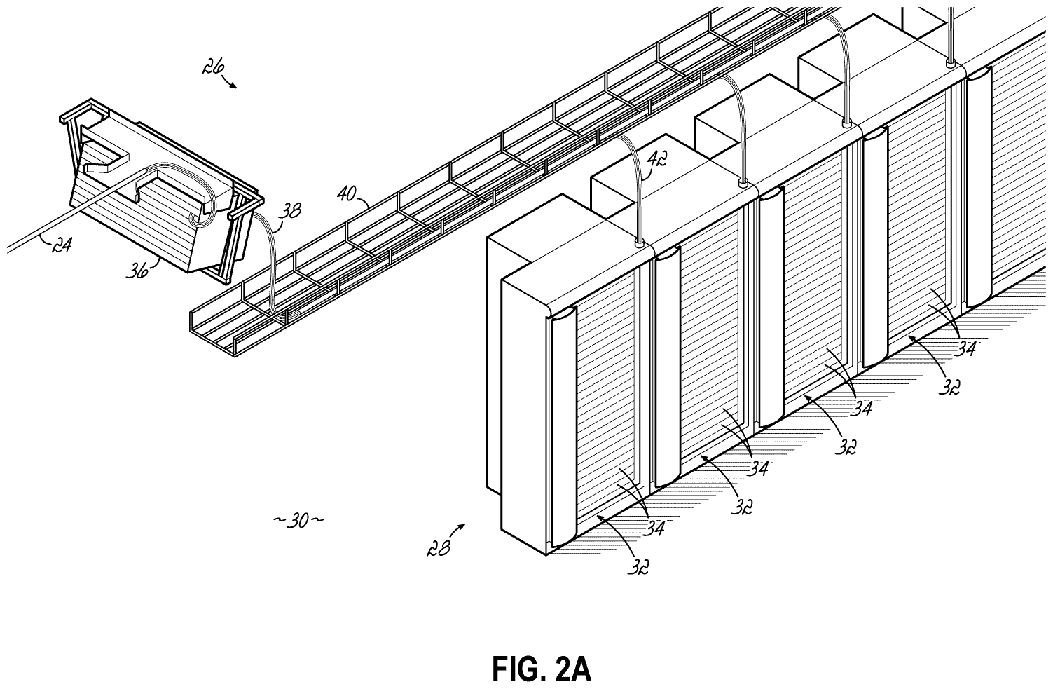

As illustrated in more detail in FIGS. 2 and 2A, the network equipment 18 in the main building 12 or an auxiliary building 14 may be arranged in one or more data halls 26 that generally include a plurality of spaced-apart rows 28 on one or both sides of an access pathway 30. The arrangement of the data halls 26 into rows 28 helps organize the large number of equipment, fiber optic cables, fiber optic connections, etc. Each of the rows 28 includes a plurality of racks or cabinets 32 generally arranged one next to the other along the row 28. Each of the racks 32 are vertically arranged frames having one or more network equipment trays 34 (e.g., FIG. 2A) for holding certain network equipment of the data center 10, for example.

In one common arrangement, as illustrated in FIGS. 2 and 2A, each row 28 may include an intermediate distribution frame 36, otherwise referred to as a goal post, at the front or head end of the row 28 closest to the access pathway 30. The intermediate distribution frame 36 represents a termination point of at least some of the optical fibers carried by one or more of the indoor cables 24, for example. Although the intermediate distribution frame 36 is shown as being positioned above the row 28, in other embodiments the intermediate distribution frame 36 may be in a cabinet (not shown) at the head end of the row 28, or in the first rack 32 at the head end of the row 28. In yet other embodiments, the intermediate distribution frame 36 may be located within the associated row 28, such as in the middle of the row 28, and be above, below, or within one of the racks 32. In other embodiments, the intermediate distribution frame 36 is not needed.

As shown in FIG. 2A, at least one row distribution cable 38 is connected to the intermediate distribution frame 36 of a row 28 and routed along a cable tray 40 generally disposed above the row 28. For example, the at least one row distribution cable 38 may be located in the cable tray 40 or suspended below the cable tray 40 by hooks, clips, or other suitable fasteners. In either case, each equipment tray 34 contained within a respective rack 32, and in particular the network equipment held in each equipment tray 34, is optically connected to the at least one row distribution cable 38 with one or more feeder cables 42 to provide the interconnectivity of the network equipment 18 of the data center 10. The feeder cables 42 may be routed from the cable tray 40 to the rack 32 where they may be terminated at each tray 34 within the rack 32.

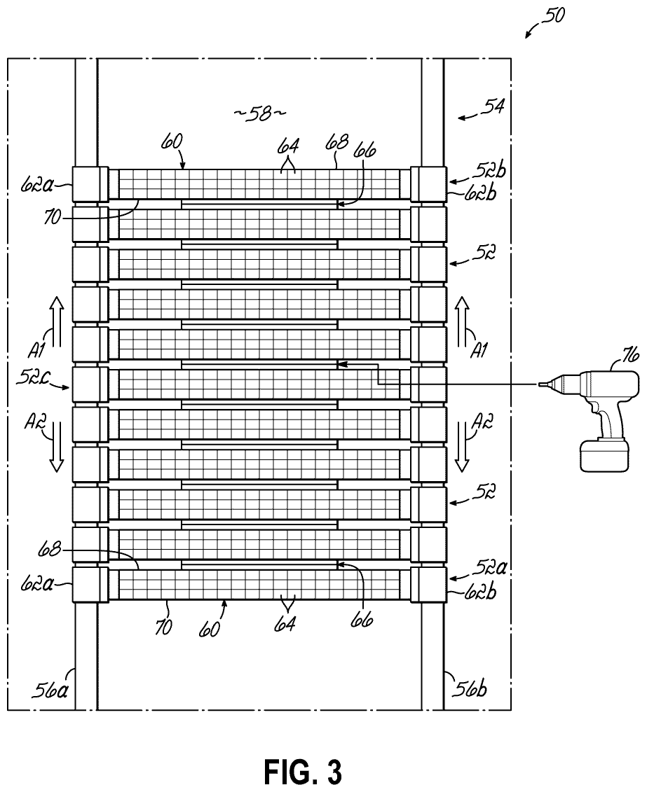

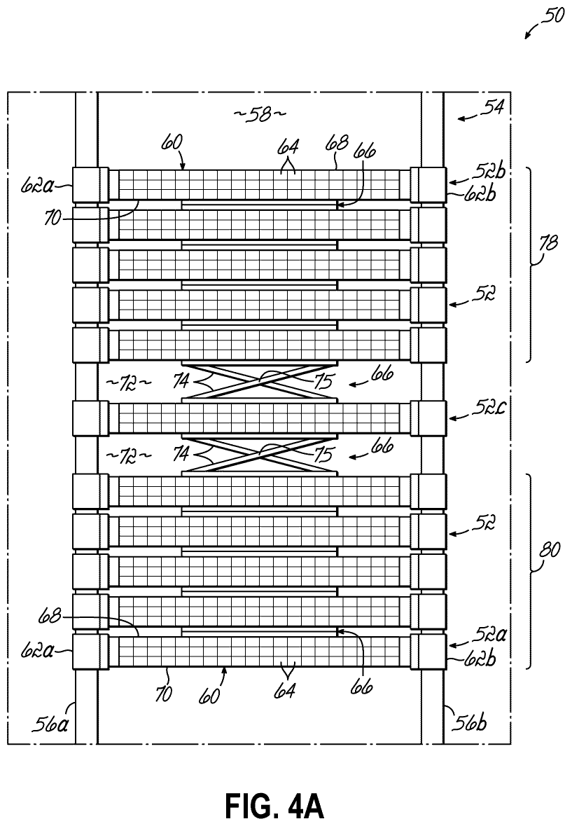

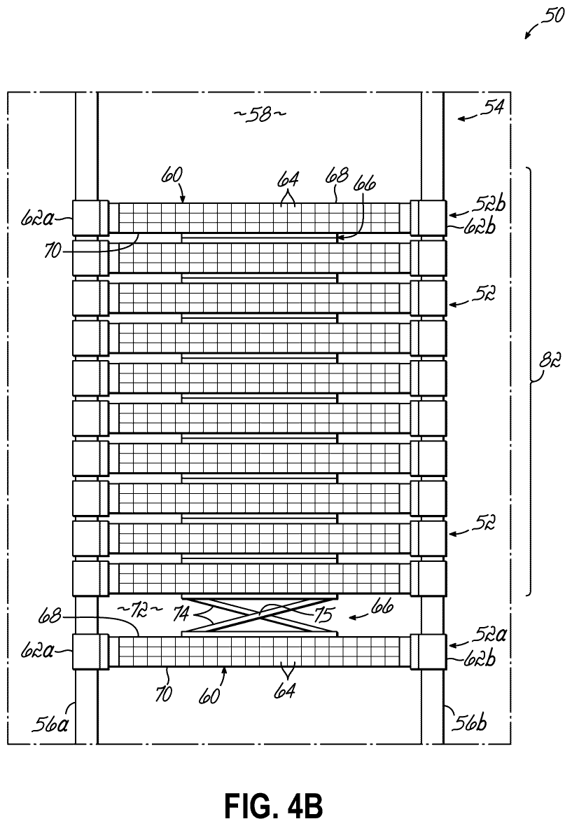

Referring now to FIGS. 3-4B, certain structural components, but not all components, of an exemplary rack system 50 are shown in accordance with embodiments of the disclosure. In one embodiment, the rack system 50 may be implemented in one or more of the equipment racks 32 of the data center 10 described above, for example. Additionally or alternatively, the rack system 50 may be implemented in one or more of the intermediate distribution frames 36 of the data center 10 described above. To this end, the rack system 50 may be implemented in any equipment rack of a fiber optic network through which fiber optic cables are routed for connection.

With continued reference to FIGS. 3-4B, the rack system 50 is configured to receive one or more feeder cables, which may be any one of the feeder cables 16, distribution cables 20, drop cables 24, or feeder cables 42 in FIGS. 1-2A. In that regard, the rack system 50 is configured to movably support a plurality of rack assemblies 52 to which the feeder cables 42 may be routed. In particular, the rack system 50 includes an equipment rack 54 that is configured to house certain network equipment and receive the feeder cable 42 within its interior. The equipment rack 54 may include a pair of opposing vertical frame members 56a, 56b between which each rack assembly 52 is movably supported, as will be described in further detail below. The vertical frame members 56a, 56b generally define a space 58 within the equipment rack 54 to house the rack assemblies 52. For example, a height of each rack assembly 52 may be approximately 1 U. Per EIA-310 specifications, 1 U may be approximately 1.75 inches. A width of each rack assembly 52 may be 19 inches, 21 inches, or 23 inches, for example. It will be understood that the rack system 50 may include fewer or more rack assemblies 52 than what is shown in the figures.

Each rack assembly 52 may include a main tray or shelf 60 that extends between a pair of brackets 62a, 62b. The tray 60 is configured to support network equipment, which may include one or more adapters and connectors 64, to facilitate optical connections of the feeder cables that are terminated at each rack assembly 52. Each rack assembly 52 is movably coupled to the pair of frame members 56a, 56b by the brackets 62a, 62b. In that regard, each bracket 62a, 62b is configured to slide vertically along the frame member 56a, 56b to which it is attached, allowing the rack assembly 52 to move vertically within the equipment rack 54. For example, each bracket 62a, 62b may be a sleeve configured to wrap partially or completely around the respective frame member 56a, 56b. Alternatively, the frame members 56a, 56b may include a rail that receives a corresponding bracket 62a, 62b, allowing the bracket 62a, 62b to slide vertically along the rail. Regardless, the brackets 62a and 62b provide the rack assemblies 52 with the capability to move vertically within the equipment rack 54. This vertical movement may include both upward motion, indicated by directional arrows A1, and downward motion, indicated by directional arrows A2.

With continued reference to FIGS. 3-4B, the rack system 50 includes a plurality of spacing devices that are configured to selectively move one or more rack assemblies 52 within the equipment rack 54. In the embodiment shown, each spacing device is in the form of a scissor lift 66. However, the spacing device may be a jack, rack and pinion system, a worm gear, a linear actuator, a belt drive system, or any other suitable means for transmitting vertical motion. As shown in FIG. 3, each scissor lift 66 is engaged with a top 68 of the tray 60 of one lower rack assembly 52 and also with a base 70 of the tray 60 of one upper rack assembly 52 in the stack. Each scissor lift 66 is generally sandwiched between adjacent rack assemblies 52. As will be described in further detail below, actuation of one scissor lift 66 spaces the upper one or more rack assemblies 52 above the scissor lift 66 away from the lower one or more rack assemblies 52 below the scissor lift 66 to increase or create a working space 72 (e.g., FIGS. 4A-4B) between rack assemblies 52.

A lowermost rack assembly 52a in the stack may include a scissor lift 66 in engagement with only the top 68 of its tray 60. In that regard, the lowermost rack assembly 52a may be fixed to the equipment rack 54, for example, and the scissor lift 66 may be configured to move the rack assemblies 52 located above the lowermost rack assembly 52a. Similarly, a topmost rack assembly 52b in the stack may only include a scissor lift 66 in engagement with the base 70 of its tray 60. The scissor lift 66 may be configured to move the topmost rack assembly 52b from the rack assemblies 52 located therebelow. To this end, the topmost rack assembly 52b may be movable within the equipment rack 54. The number of scissor lifts 66 in the rack system 50 may be one less than the number of rack assemblies 52. In the exemplary embodiment shown, the rack system 50 includes eleven (11) rack assemblies 52 and ten (10) scissor lifts 66. However, the number of rack assemblies 52 and scissor lifts 66 may vary depending on the particular application.

With reference to FIGS. 3 and 4A, each scissor lift 66 may include one or more scissor arms 74 connected together at a pivot point 75, with at least one of the scissor arms 74 being movable by a linear drive (not shown). The ends of each scissor arm 74 may be operatively attached to adjacent rack assemblies 52. In other words, each scissor arm 74 extends between, and is operatively secured to, adjacent rack assemblies 52. The linear drive may be a driveshaft, gear mechanism, or actuator configured to generate the linear motion required to extend or collapse the scissor arms 74 to space adjacent rack assemblies 52 apart. In the embodiment shown, each scissor lift 66 may be selectively operable with a handheld tool, such as a hand drill 76, for example. In that regard, each scissor lift 66 or rack assembly 52 may include an attachment point configured to receive the chuck of the hand drill 76. At the attachment point, the rotational energy of the hand drill 76 is transferred to the linear drive to produce the essential linear motion for extending or contracting the scissor arms 74 of the associated scissor lift 66. The action of the scissor arms 74, in turn, induces vertical movement in one or more of the rack assemblies 52 to increase the working space 72 surrounding a rack assembly 52 targeted for isolation. In another embodiment, the linear drive of each scissor lift 66 may be driven by a motor. The motor may be locally or remotely operated to drive movement of the one or more rack assemblies 52.

An exemplary operation of the rack system 50 will now be described with reference to FIGS. 3 and 4A. In that regard, FIG. 3 illustrates the stack of rack assemblies 52 in an operative position, with each scissor lift 66 in a retracted position such that the plurality of rack assemblies 52 are arranged closely together in a stack in the equipment rack 54. When so positioned, there may be little to no available working space 72 between each rack assembly 52. Turning now to FIG. 4A, it may be desired to isolate one or more rack assemblies 52, e.g., a targeted rack assembly 52c, within the equipment rack 54 for maintenance or installation activities. In that regard, FIG. 4A illustrates the stack of rack assemblies 52 in one exemplary expanded position, with one or more scissor lifts 66 in an expanded position to space apart one or more of the rack assemblies 52 to increase the available working space 72 about each targeted rack assembly 52c.

FIG. 4A illustrates an operation of the rack system 50 to separate or space rack assemblies 52 in the stack to increase working space 72 about a single targeted rack assembly 52c. In that regard, the scissor lift 66 engaged with the base 70 of the targeted rack assembly 52c may be operated to move the targeted rack assembly 52c and an upper portion 78 of the plurality of rack assemblies 52 in an upward direction and away from a lower portion 80 of the plurality of rack assemblies 52. This initial operation will create or increase the working space 72 beneath the targeted rack assembly 52c. The working space 72 beneath the targeted rack assembly 52c may be referred to as a lower or underside working space 72. Next, the scissor lift 66 engaged with the top 68 of the targeted rack assembly 52c may be operated to move the upper portion 78 of the plurality of rack assemblies 52 in an upward direction and away from the targeted rack assembly 52c. This operation will create or increase the working space 72 above the targeted rack assembly 52c. The working space 72 above the targeted rack assembly 52c may be referred to as an upper or topside working space 72. While only one rack targeted assembly 52c is isolated in FIG. 4A, it will be understood that the process described above may be repeated to isolate any number of rack assemblies 52 in the equipment rack 54. Further, the rack system 50 may be operated to isolate a group of two or more rack assemblies 52. Once the maintenance or installation activities have concluded, the expanded scissor lifts 66 may be retracted or collapsed to return the rack system 50 to the operative position shown in FIG. 3.

FIG. 4B illustrates another exemplary operation of the rack system 50 to increase working space 72 about the lowermost rack assembly 52a in the equipment rack 54. As briefly described above, the lowermost rack assembly 52a may be fixed relative to the frame members 56a, 56b of the equipment rack 54. As a result, the lowermost rack assembly 52a may serve as a support to accommodate movement of a remainder 82 of the rack assemblies 52 in the equipment rack 54. As shown, the scissor lift 66 engaged with the top 68 of the lowermost rack assembly 52a is operated to move the remainder 82 of the rack assemblies 52 in the equipment rack 54 in an upward direction and away from the top 68 of the lowermost rack assembly 52a. As a result, the working space 72 above lowermost rack 52a assembly is increased.

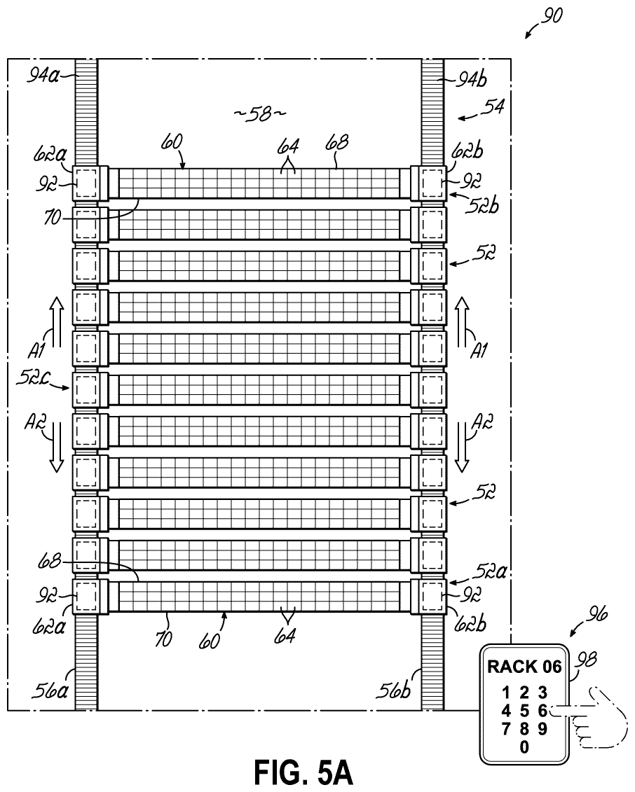

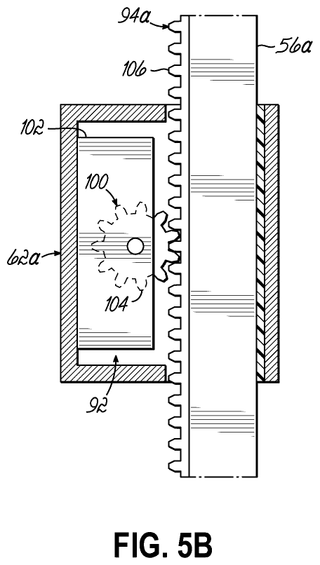

Referring now to FIGS. 5A and 5B, wherein like numerals represent like features compared to the embodiments described above with respect to FIGS. 1-4B, another embodiment of a rack system 90 is shown and will now be described. The primary differences between the rack system 90 of this embodiment and the rack system 50 of the previously described embodiment is the configuration of the lifting device for vertically moving each rack assembly 52 within equipment rack 54. In that regard, each rack assembly 52 of the rack system 90 includes at least one motorized drive 92 configured to drive vertical movement of the rack assembly 52 relative to the equipment rack 54.

As described above, each rack assembly 52 includes the pair of brackets 62a, 62b configured to engage respective vertical frame members 56a, 56b. As shown in FIGS. 5A and 5B, each bracket 62a, 62b may be in the form of a sleeve that wraps partially or completely around the respective frame member 56a, 56b. Each bracket 62a, 62b includes one motorized drive 92 that is configured to engage the respective vertical frame member 56a, 56b received through the bracket 62a, 62b to drive movement of the rack assembly 52. In that regard, each vertical frame member 56a, 56b may include a track 94a, 94b configured to receive the motorized drive 92 housed in each bracket 62a, 62b. Each track 94a, 94b may extend for a length of the respective frame member 56a, 56b, as shown. As will be described in further detail below, each motorized drive 92 is configured to engage the respective track 94a, 94b to drive vertical movement of the rack assembly 52 within the equipment rack 54. To this end, each rack assembly 52 may include a pair of motorized drives 92, with one motorized drive 92 being housed in each bracket 62a, 62b. In an alternative embodiment, each rack assembly 52 may only include one motorized drive 92.

With continued reference to FIG. 5A, the rack system 90 may include a controller 96 for remotely operating the rack system 90. The controller 96 may be operatively connected to each rack assembly 52, and in particular the motorized drives 92 of each rack assembly 52, to control the positioning and movement of each rack assembly 52 within the network rack 54. In that regard, a human machine interface (HMI) 98 may be operatively connected to the controller 96 to provide a technician with the ability to operate movement of the rack assemblies 52 of the rack system 90. The HMI 98 is configured to receive an operation input from a technician that is indicative of one or more rack assemblies 52 desired to be isolated for maintenance or installation activities. The HMI 98 may include a keypad, for example. In the exemplary embodiment shown, rack assembly 52 number “06” (i.e., the sixth rack assembly 52 counted from the lowermost rack assembly 52a) may be targeted for maintenance, and may be referred to as the targeted rack assembly 52c. Thus, the technician's input into the HMI 98 is rack assembly 52 number “06”. The controller 96 receives this operation input and operates the motorized drives 92 of each of the rack assemblies 52 above and below the targeted rack assembly 52c, as indicated by directional arrows A1 and A2, to isolate and increase the working space 72 about targeted rack assembly 52c. As each of the rack assemblies 52 is independently movable, different movement patterns of rack assemblies 52 within the equipment rack 54 are possible to isolate the one or more targeted rack assemblies 52c. In that regard, it will be understood that the rack system 90 may be operated to isolate one, several, or a group of two or more rack assemblies 52. Once the maintenance or installation activities have concluded, the rack assemblies 52 may be operated to return the rack system 90 to the operative position shown in FIG. 5A.

FIG. 5B illustrates additional details of one exemplary motorized drive 92 of a rack assembly 52. The motorized drive 92 includes a gear 100 driven by a motor 102. The motor 102 and the gear 100 may be contained within the bracket 62a of the rack assembly 52, as shown. The outer circumference of the gear 100 includes a plurality of gear teeth 104 that are configured to mesh with teeth 106 on the track 94a of a frame member 56a of the equipment rack 54. To that end, the gear teeth 104 are shaped to ensure smooth and efficient transfer of motion and power to drive movement of the rack assembly 52 along the frame members 56a, 56b of the equipment rack 54. When not in motion, each motor 102 may be configured to prevent any movement of the rack assembly 52 in relation to the equipment rack 54 to ensure that the rack assembly 52 remains in a specific position within the equipment rack 54. For instance, the motor 102 of each motorized drive 92 may include a brake mechanism (not shown) that is configured to halt or lock both the motor 102 and movement of the gear 100 when the motor 102 is not powered.

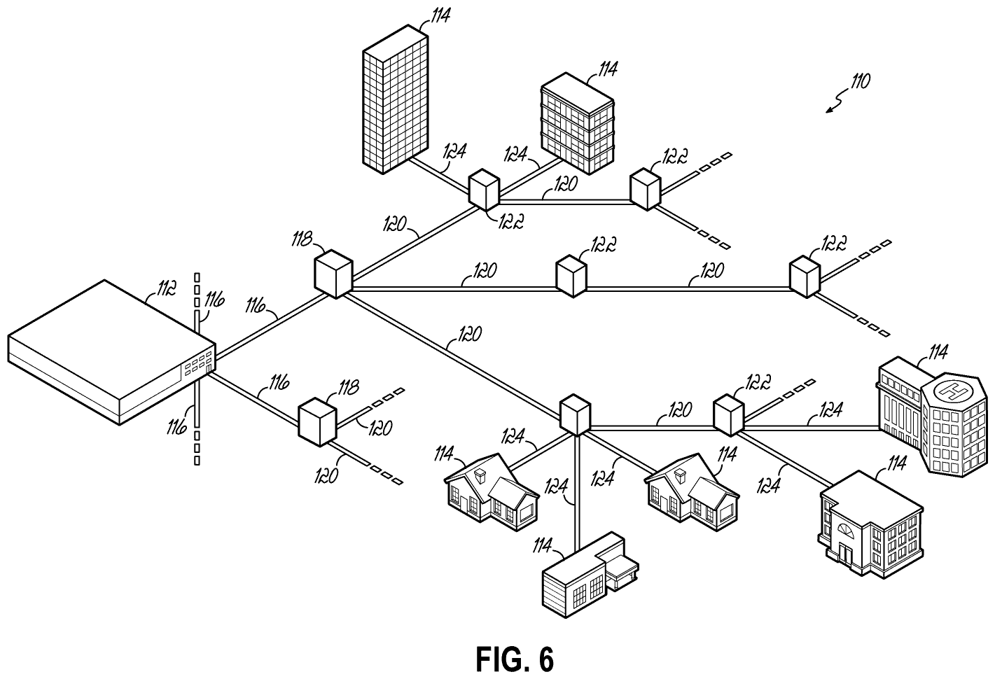

As briefly described above, the rack system 50, 90 may be for managing fiber optic cables in a fiber optic network, such as a data center 10 or a FTTx carrier network 110. FIG. 6 illustrates an exemplary FTTx carrier fiber optic network 110 which distributes optical signals generated at a switching point 112 (e.g., a central office) to one or more subscriber premises 114. Optical line terminals (OLTs—not shown) at the switching point 112 convert electrical signals into optical signals. Fiber optic feeder cables 116 then carry the optical signals to various local convergence points 118. The convergence points 118 act as locations for making cross-connections and interconnections (e.g., by splicing or patching cables). The local convergence points 118 often include splitters or WDM components to enable any given optical fiber in the feeder cable 116 to serve multiple subscriber premises 114. As a result, the optical signals are “branched out” from the optical fibers of the feeder cables 116 to optical fibers of fiber optic distribution cables 120 that exit the local convergence points 118.

At remote network access points 122 closer to the subscriber premises 114, some or all the optical fibers in the distribution cables 120 may be accessed to connect to one or more subscriber premises 114. Drop cables 124 extend from the network access points 122 to the subscriber premises 114, which may be single-dwelling units (SDU), multi-dwelling units (MDU), businesses, and/or other facilities or buildings. An optical network terminal (ONT—not shown) located at or inside the subscriber premises 114 receives one or more optical signals and converts the optical signals back to electrical signals at the remote distribution points or subscriber premises 114. Rack systems 50, 90 may be located in any single one or each of the switching points 112, local convergence points 118, and/or remote network access points 122 in the carrier network 110.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A rack system of a fiber optic network, comprising:
an equipment rack having a first vertical frame member opposing a second vertical frame member;
a plurality of rack assemblies arranged in a stack in the equipment rack between the first vertical frame member and the second vertical frame member with at least a first rack assembly being vertically movable relative to an adjacent second rack assembly, each of the plurality of rack assemblies being configured to facilitate one or more optical connections of the fiber optic network; and
at least one spacing apparatus selectively operable to vertically move the first rack assembly relative to the second rack assembly to create a working space therebetween.

2. The rack system of claim 1, wherein a height of each of the plurality of rack assemblies is approximately 1 U.

3. The rack system of claim 1, wherein the first rack assembly is positioned above the second rack assembly and vertical movement of the first rack assembly is upward relative to the second rack assembly to create the working space.

4. The rack system of claim 1, wherein the at least one spacing apparatus is configured to vertically move the first rack assembly and an upper portion of the plurality of rack assemblies in the stack that is positioned above the first rack assembly.

5. The rack system of claim 1, wherein the at least one spacing apparatus comprises a scissor lift.

6. The rack system of claim 5, wherein the scissor lift is secured between the first rack assembly and the second rack assembly.

7. The rack system of claim 5, wherein the scissor lift is selectively operable with a handheld tool.

8. The rack system of claim 1, wherein the at least one spacing apparatus comprises a scissor lift positioned between each one of the plurality of rack assembles, wherein each scissor lift is operable to vertically move an upper portion of the plurality of rack assemblies in the stack relative to a lower portion of the plurality of rack assemblies in the stack to create a working space therebetween.

9. The rack system of claim 1, wherein the at least one spacing apparatus comprises a motorized drive configured to vertically move the first rack assembly relative to the second rack assembly.

10. The rack system of claim 9, wherein the motorized drive comprises a gear located on the first rack assembly that is configured to engage a track located on the equipment rack to drive vertical movement of the first rack assembly, the gear being selectively driven by a motor.

11. The rack system of claim 10, wherein at least the first rack assembly includes a first bracket configured to engage the first vertical frame member and a second bracket configured to engage the second vertical frame member, wherein one of the first or second brackets houses the gear and motor and a corresponding one of the first or the second vertical frame members includes the track.

12. The rack system of claim 1, wherein the at least one spacing apparatus comprises a plurality of motorized drives, each motorized drive being configured to vertically move one of the plurality of rack assemblies.

13. The rack system of claim 9, further comprising:
a controller operatively connected to each motorized drive;
a human machine interface (HMI) operatively connected to the controller, the HMI being configured to receive an operation input from a user;
the controller being configured to operate the rack system as follows:
receive an operation input from the HMI indicative of the second rack assembly; and
operate at least the motorized drive of the first rack assembly to vertically move the first rack assembly relative to the second rack assembly to create the working space therebetween.

14. A distribution frame of a fiber optic network including the rack system of claim 1.

15. A method of separating adjacent rack assemblies in a rack system of a fiber optic network, comprising:
providing the rack system having an equipment rack with a first vertical frame member opposing a second vertical frame member, a plurality of rack assemblies arranged in a stack in the equipment rack between the first vertical frame member and the second vertical frame member with one or more of the plurality of rack assemblies being vertically movable relative to the equipment rack by means of at least one spacing apparatus; and
operating the at least one spacing apparatus to vertically move at least a first rack assembly relative to at least a second rack assembly to create the working space therebetween.

16. The method of claim 15, wherein the at least one spacing apparatus comprises a plurality of scissor lifts, each scissor lift being configured to vertically move one of the plurality of rack assemblies, the method further comprising:
operating at least one scissor lift to vertically move the first rack assembly relative to the second rack assembly to create the working space therebetween.

17. The method of claim 15, wherein the at least one spacing apparatus comprises a plurality of motorized drives, each motorized drive being configured to vertically move one of the plurality of rack assemblies, the method further comprising:
operating at least one motorized drive to vertically move the first rack assembly relative to the second rack assembly to create the working space therebetween.

18. The method of claim 17, wherein the rack system further comprises a controller operatively connected to each motorized drive and a human machine interface (HMI) operatively connected to the controller, the HMI being configured to receive an operation input from a user, the operation input being indicative of a targeted rack assembly of one of the plurality of rack assemblies, the method further comprising:
receiving by the controller the operation input from the HMI indicative of the targeted rack assembly; and
operating at least the motorized drive of a rack assembly directly above the targeted rack assembly to vertically move the rack assembly directly above the targeted rack assembly to create a working space therebetween.
